(19) United States
(12) Patent Application Publication
(10) Pub. No.: US 2026/0313714 A1
(43) Pub. Date: Oct. 8, 2026

(54) METHOD AND DEVICE FOR TRANSMITTING OR RECEIVING PREAMBLE FOR RANDOM ACCESS DURING HANDOVER IN WIRELESS COMMUNICATION SYSTEM

(71) Applicant: SAMSUNG ELECTRONICS CO., LTD., Suwon-si, Gyeonggi-do (KR)

(72) Inventors: Younghoon JO, Suwon-si (KR); Juho LEE, Suwon-si (KR); Bohyun KANG, Suwon-si (KR); Jaeeun KANG, Suwon-si (KR); Youngdae KOO, Suwon-si (KR); Jaheon GU, Suwon-si (KR); Saerome KIM, Suwon-si (KR); Ilju NA, Suwon-si (KR); Jongmin SHIN, Suwon-si (KR); Hoyoung YOON, Suwon-si (KR)

(21) Appl. No.: 19/128,923

(22) PCT Filed: Nov. 9, 2023
(86) PCT No.: PCT/KR2023/018013

§ 371 Date: May 9, 2025

(30) Foreign Application Priority Data
Nov. 11, 2022 (KR) 10-2022-0150496

(51) Int. Cl. H04W 74/0838; H04W 36/00; H04W 36/08; H04W 36/30; H04W 74/00

(52) U.S. Cl. CPC H04W 74/0838; H04W 36/0072; H04W 36/085; H04W 36/304; H04W 74/006

(57) ABSTRACT

The present disclosure relates to a 5G or 6G communication system for supporting a higher data transmission rate beyond a 4G communication system such as LTE. The present disclosure relates to a method and a device for transmitting or receiving a preamble for random access, which can reduce a time delay during handover in a wireless communication system, and a method of a terminal for random access during handover from a source cell to a target cell in a wireless communication system according to an embodiment of the present disclosure comprises the steps of: transmitting measurement information of the source cell and the target cell to a first base station of the source cell; receiving an RRC message including RACH configuration information of the target cell from the first base station; and sequentially transmitting one or more preambles for the random access to a second base station of the target cell on the basis of the RACH configuration information, wherein the RACH configuration information includes, as list information, multiple preamble indices and multiple SSB indices mapped to multiple ROs for transmitting the one or more preambles by the terminal in a random access procedure.

### TECHNICAL FIELD

The disclosure relates to a method and device for transmitting/receiving a preamble for random access in a wireless communication system.

### BACKGROUND ART

Considering the development of wireless communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, radio frequency (RF) elements, antennas, novel waveforms having a better coverage than orthogonal frequency division multiplexing (OFDM), beamforming and massive multiple input multiple output (MIMO), full dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, high-altitude platform stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of artificial intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as mobile edge computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended reality (XR), high-fidelity mobile hologram, and digital replica could be provided through 6G communication systems. In addition, services such as remote surgery for security and reliability enhancement, industrial automation, and emergency response will be provided through the 6G communication system such that the technologies could be applied in various fields such as industry, medical care, automobiles, and home appliances.

### DETAILED DESCRIPTION OF THE INVENTION

### Technical Problem

The disclosure provides a method and device for transmitting/receiving a preamble for random access capable of reducing a time delay during handover in a wireless communication system.

Further, the disclosure provides a method and device for transmitting/receiving preamble(s) for random access using a plurality of synchronization signal blocks (SSB) in a wireless communication system.

### Technical Solution

According to an embodiment of the disclosure, a method of a UE for random access during handover from a source cell to a target cell in a wireless communication system comprises transmitting measurement information about the source cell and the target cell to a first base station of the source cell, receiving an RRC message including RACH configuration information about the target cell from the first base station, sequentially transmitting at least one preamble for the random access to a second base station of the target cell based on the RACH configuration information. The RACH configuration information includes a plurality of SSB indices and a plurality of preamble indices mapped to a plurality of ROs for the UE to transmit the at least one preamble in a random access procedure as list information.

Further, according to an embodiment of the disclosure, a UE performing random access during handover from a source cell to a target cell in a wireless communication system comprises a transceiver and at least one processor configured to transmit, through the transceiver, measurement information about the source cell and the target cell to a first base station of the source cell, receive, through the transceiver, an RRC message including RACH configuration information about the target cell from the first base station, and sequentially transmit, through the transceiver, at least one preamble for the random access to a second base station of the target cell based on the RACH configuration information. The RACH configuration information includes a plurality of synchronization signal block indices and a plurality of preamble indices mapped to a plurality of ROs for the UE to transmit the at least one preamble in a random access procedure as list information.

Further, according to an embodiment of the disclosure, a method performed by a base station of a target cell for random access during handover from a source cell to the target cell in a wireless communication system comprises transmitting an RRC message including RACH configuration information about the target cell to a first base station of the source cell, and sequentially receiving at least one preamble for the random access from a UE based on the RACH configuration information. The RACH configuration information includes a plurality of synchronization signal block indices and a plurality of preamble indices mapped to a plurality of ROs for the UE to transmit the at least one preamble in a random access procedure as list information.

Further, according to an embodiment of the disclosure, a base station of a target cell supporting random access during handover from a source cell to the target cell in a wireless communication system comprises a transceiver and at least one processor configured to transmit, through the transceiver, an RRC message including RACH configuration information about the target cell to a first base station of the source cell, and sequentially receive, through the transceiver, at least one preamble for the random access from a UE based on the RACH configuration information. The RACH configuration information includes a plurality of synchronization signal block indices and a plurality of preamble indices mapped to a plurality of ROs for the UE to transmit the at least one preamble in a random access procedure as list information.

### BRIEF DESCRIPTION OF DRAWINGS

FIGS. 1A and 1B are views illustrating an example of a handover procedure in a general wireless communication system;

FIG. 2 is a view illustrating an example of RACH configuration information provided through RRC information together with a handover command to a UE in a general handover procedure;

FIG. 3 is a view illustrating an increase in a waiting time (delay time) that occurs during transmission/reception of a preamble for random access in a general handover procedure;

FIG. 4 is a view illustrating a method for transmitting/receiving a preamble for random access during handover in a wireless communication system according to an embodiment of the disclosure;

FIG. 5 is a flowchart illustrating a method for transmitting/receiving a preamble for random access during handover in a wireless communication system according to an embodiment of the disclosure;

FIGS. 6A, 6B, and 6C are views illustrating various configuration examples of a UE performing a random access procedure during handover in a wireless communication system according to an embodiment of the disclosure;

FIG. 7 is a view illustrating an example of an operation of transmitting/receiving a preamble for random access during handover according to an embodiment of the disclosure; and

FIG. 8 is a view illustrating a configuration of a network entity in a wireless communication system according to an embodiment of the disclosure.

### MODE FOR CARRYING OUT THE INVENTION

Hereinafter, the operational principle of the disclosure is described below with reference to the accompanying drawings. When determined to make the subject matter of the present disclosure unclear, the detailed of the known functions or configurations may be skipped. The terms as used herein are defined considering the functions in the present disclosure and may be replaced with other terms according to the intention or practice of the user or operator. Therefore, the terms should be defined based on the overall disclosure.

Advantages and features of the present disclosure, and methods for achieving the same may be understood through the embodiments to be described below taken in conjunction with the accompanying drawings. However, the present invention is not limited to the embodiments disclosed herein, and various changes may be made thereto. The embodiments disclosed herein are provided only to inform one of ordinary skilled in the art of the category of the present disclosure. The present invention is defined only by the appended claims. The same reference numeral denotes the same element throughout the specification.

It should be appreciated that the blocks in each flowchart and combinations of the flowcharts may be performed by computer program instructions.

Further, each block may represent a module, segment, or part of a code including one or more executable instructions for executing a specified logical function(s). Further, it should also be noted that in some replacement embodiments, the functions mentioned in the blocks may occur in different orders. For example, two blocks that are consecutively shown may be performed substantially simultaneously or in a reverse order depending on corresponding functions.

As used herein, the term “unit” means a software element or a hardware element such as a field-programmable gate array (FPGA) or an application specific integrated circuit (ASIC). A unit plays a certain role. However, ‘unit’ is not limited to software or hardware. A ‘unit’ may be configured in a storage medium that may be addressed or may be configured to execute one or more processors. Accordingly, as an example, a ‘unit’ includes elements, such as software elements, object-oriented software elements, class elements, and task elements, processes, functions, attributes, procedures, subroutines, segments of program codes, drivers, firmware, microcodes, circuits, data, databases, data architectures, tables, arrays, and variables. Functions provided within the components and the ‘units’ may be combined into smaller numbers of components and ‘units’ or further separated into additional components and ‘units’. Further, the components and ‘units’ may be implemented to execute one or more CPUs in a device or secure multimedia card. According to embodiments, a “ . . . unit” may include one or more processors.

As used herein, each of such phrases as “A/B,” “A or B,” “A and/or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order).

As used herein, terms for identifying access nodes, terms denoting network entities, terms denoting messages, terms denoting inter-network entity interfaces, and terms denoting various pieces of identification information are provided as an example for ease of description. Thus, the disclosure is not limited to the terms, and the terms may be replaced with other terms denoting objects with equivalent technical meanings.

In the disclosure, the base station (BS) is a network entity allocating resources to the UE and capable of communicating with the UE and may be at least one of an eNode B, a Node B, a gNB, a radio access network (RAN), an access network (AN), a RAN node, an integrated access/backhaul (IAB) node, a radio access unit, a base station controller, a node over network, or a transmission reception point (TRP). The user equipment (UE) may be at least one of a terminal, a mobile station (MS), cellular phone, smartphone, computer, or multimedia system capable of performing communication functions.

The disclosure proposes a method for reducing the waiting time during handover and increasing the probability of success in random access by allowing a UE moving in a wireless communication system to use a plurality of SSBs during transmission/reception of a preamble for random access during handover (i.e., cell-to-cell mobility) that occurs when it is required to change the connected base station.

First, a general handover procedure in a wireless communication system is described to help understanding of the disclosure.

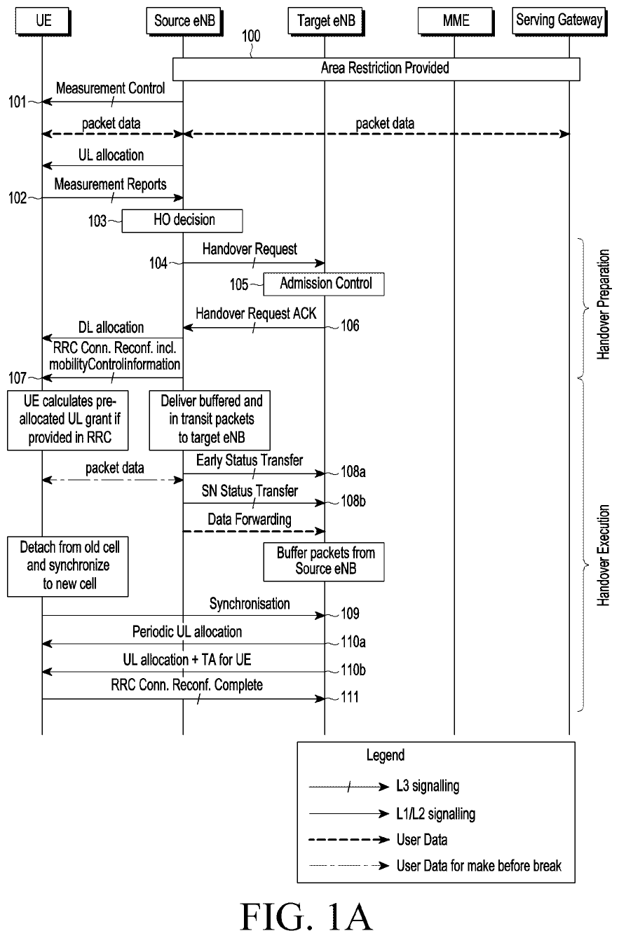

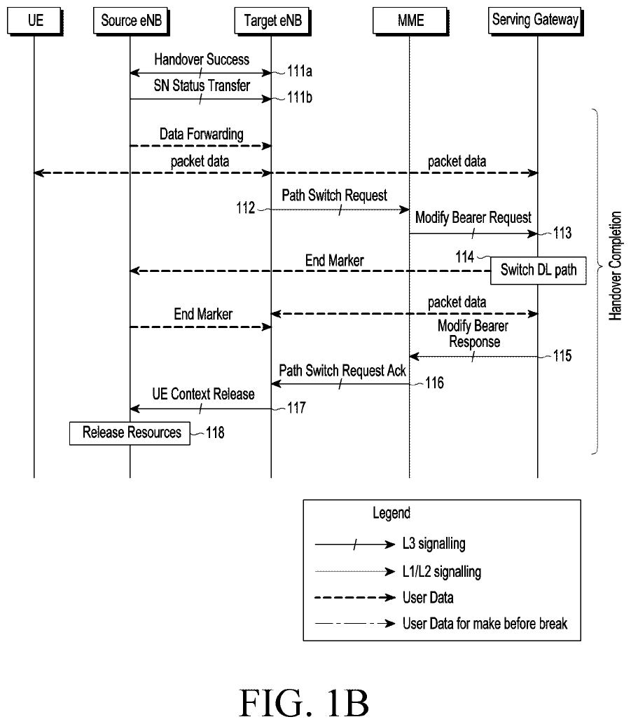

FIGS. 1A and 1B are views illustrating an example of a handover procedure in a general wireless communication system. The examples of FIGS. 1A and 1B show the handover procedure in the LTE system, and the handover procedure of the 5G (NR) system is also performed in substantially the same way as the procedure of FIG. 1. In LTE, LTE-A, or 5G systems, L3 handover (i.e., cell-to-cell mobility) may be performed according to procedures defined in 3GPP TS36.300 or TS38.300. In the examples of FIGS. 1A and 1B, procedures based on 3GPP TS36.300 release 16 are illustrated, and the entire handover procedure for the 5G system is substantially the same as the examples of FIGS. 1A and 1B except that the source gNB and the target gNB play a role as the source eNB and the target eNB, the access and mobility management function (AMF) plays a role as the mobility management entity (MME) managing the mobility of the UE, and the user plane function (UPF) plays a role as the serving gateway (S-GW) managing the transfer of user traffic. Descriptions of content not directly related to the disclosure may be omitted from the descriptions of FIGS. 1A and 1B.

The handover procedure of FIGS. 1A and 1B may be largely divided into four steps (hereinafter referred to as steps 1 to 4).

Step 1: The serving eNB/gNB transmits configuration information (measurement object, report configuration, measurement ID, etc.) for channel state measurement of the UE to the UE 101, and the UE measures the channel state (i.e., received signal strength/quality) based on the configuration information and reports it to the serving eNB/gNB (102). In this case, the UE may measure the received signal strength/quality of the source cell (serving/source eNB/gNB/cell) (hereinafter referred to as “source cell”) and neighbor cells (neighbor eNB/gNB/cells) and transmit the measurement information to the source cell periodically or when a set event occurs.

Step 2: Handover preparation step. The source cell receiving the measurement information from the UE determines whether to trigger the handover based on the measurement information (103) and, when determining to trigger handover, transmits a handover request message for performing a handover procedure with one target cell (target eNB/gNB/cell) (hereinafter, referred to as a “target cell”) with good received signal strength/quality among the neighbor cells (104). Upon receiving the handover request message, the target cell performs acceptance control for the handover (105) and, when accepting the handover, transmits a response message including cell configuration information for the handover procedure to the target cell to the source cell (106). The response message may include a target cell identifier, frequency information, preamble information required in the random access procedure to the target cell, resource information, UE identifier information (cell radio network temporal identity (C-RNTI)) used in the target cell, or the like.

Step 3: Handover execution step. The source cell transfers a handover command including the cell configuration information for a handover procedure to the target cell to the UE (107). The UE that receives the cell configuration information about the target cell through the handover command from the source cell (i.e., old cell) switches the radio frequency (RF) to perform the handover procedure to the target cell (i.e., new cell). The UE may decode the master information block (MIB) of the target cell to obtain the system frame number (SFN) of the target cell (i.e., obtain downlink (DL) synchronization), and perform a random access procedure on the target cell to obtain uplink allocation (UL grant) and timing advance (TA) of the target cell. In the random access procedure, the UE transmits a preamble to the target cell (109), and receives a random access response (RAR) message including the uplink allocation (UL grant) from the target cell that has received the preamble (110a, 110b). Upon receiving the RAR message, the UE transmits an RRC message msg3 including the UE's C-RNTI through a physical uplink shared channel (PUSCH) (111). The RRC message msg3 may use an RRC connection reconfiguration complete message (RRCConnectionReconfigurationComplete) in the case of an LTE system, and use an RRC reconfiguration complete message (RRCReconfigurationComplete) in the case of a 5G system. On the other hand, when handover without a random access procedure (Rach-less handover) is supported, in operation 107 of step 3, the timing advance (TA) value may be transferred to the UE in advance so that uplink synchronization between the UE and the target cell may be achieved in advance. Further, if dual application protocol stack (DAPS) is supported, the UE may maintain the connection with the source cell even after receiving the handover command from the target cell in operation 107. In this case, the source cell transmits an early status transfer to the target cell (108a). Then, the DL packet transferred from the source cell to the UE is duplicated and transferred to the target cell, and the transfer operation is terminated by transferring a handover success message from the target cell to the source cell through operation 111a.

Step 4: Handover complete step. If the handover is successful as in the operations of steps 1 to 3, an operation of changing the data path from the source cell to the target cell is performed in operations 112 to 118.

Hereinafter, the delay time (i.e., handover interruption time) caused by the increase in waiting time when transmitting/receiving preambles between the UE and the target cell in the random access procedure performed during handover in the wireless communication system is described.

This delay time may occur during the “detach from old cell and synchronize to new cell” operation to operation 111 in the example of FIG. 1A.

In general, in the handover procedure, the UE disconnected from the source cell decodes the MIB of the target cell for connection with the target cell. After the MIB decoding is completed, in the case of a Rach-based handover, the UE transmits a preamble for random access to the target cell through the RO corresponding to the “SSB index” designated through a combination of an available preamble index, mapping information of RACH occasion (rach occasion (RO)) in the PRACH resource and the SSB, and target cell PRACH resource periodicity information (see “pprach-config-index” in TS36/38.331) about the target cell for transmitting a preamble in the random access procedure. In the case of the Rach-based handover, when the UE successfully receives the RAR from the target cell, the UE may know the timing advance (TA) information in the RAR and the grant position of the PUSCH, and the UE may complete the random access procedure by transferring the RRC message to the target cell by the corresponding information. Meanwhile, in the case of Rach-less handover, the UE already knows the UL grant cycle of the target cell received through SFN information and handover command even without transmitting a preamble to the target cell and, thus, may directly transmit the RRC message through the physical uplink shared channel (PUSCH) through operation 110A in FIG. 1A. The disclosure is proposed to reduce a time delay due to an increase in waiting time generated in the Rach-based handover.

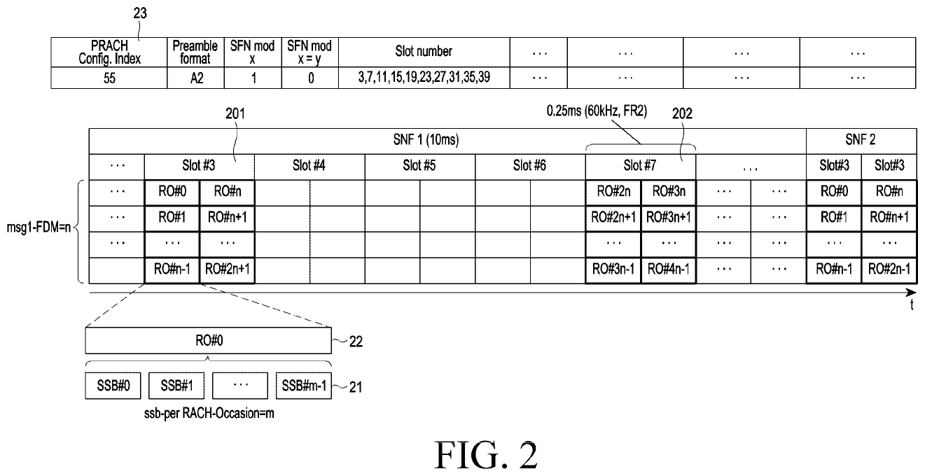

FIG. 2 is a view illustrating an example of RACH configuration information provided through RRC information together with a handover command to a UE in a general handover procedure. The example of FIG. 2 illustrates a case of using 2.5 ms as PRACH available resources per 10 ms (10 slots per 10 ms).

The RACH configuration information in FIG. 2 may refer to, e.g., RACH-ConfigDedicated information in TS 38.331. The RACH-ConfigDedicated information is included in the cell configuration information, and the RRCReconfiguration message received by the UE from the source cell in operation 107 of FIG. 1A may include the cell configuration information about the target cell. The RACH-ConfigDedicated information may include information indicating a mapping relationship between the SSB index 21 and the RO 22, as in the example of FIG. 2. The preamble index 23 represents the index of a preamble used by the UE when a random access procedure is performed by selecting the candidate beam of the target cell identified by the SSB index 21. In the example of FIG. 2, ssb-per RACH-Occasion is the number (m) of SSBs available per RACH-Occasion (RO), and the UE may perform a random access procedure using a preamble corresponding to one SSB indicated by the RO (e.g., RO #0) through RRC information. In the example of FIG. 2, the PRACH-config-index 23 is a parameter indicating the time (or period) when the UE may transmit a preamble and what type of preamble format should be transmitted. When the SSB index mapped to RO #3 is indicated as SSB #3 in slot #3 201 of SFN1 through the RRC information received together with the handover command from the source cell, the UE may transmit the preamble corresponding to SSB #3 to the target cell at RO #3 and, if failing to receive an RAR for the transmission of the preamble from the target cell, may not retransmit a preamble in a different slot (e.g., slot #7 202) in the same SFN1 and may transmit a preamble in the same slot #3 of the next SFN.

In this general handover procedure, the UE may identify the SSB index for random access to the target cell through the reserved resource in the RACH configuration information that is received together with the handover command, the target cell designates, for the UE, one preamble index that follows the contention free random access preamble (CFRA) policy, and the UE transmits a preamble for random access to the target cell at the RO mapped to one preamble index and one designated SSB index in the RACH configuration information (i.e., RACH-ConfigDedited).

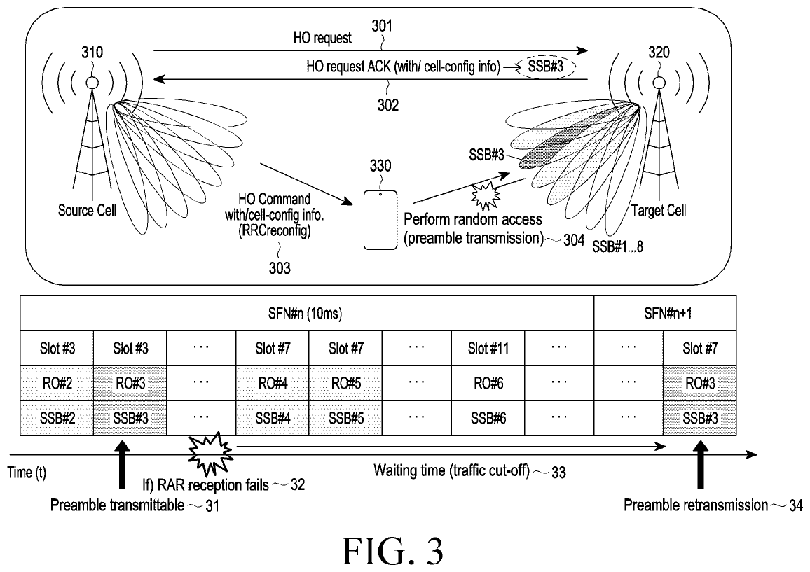

FIG. 3 is a view illustrating an increase in a waiting time (delay time) that occurs during transmission/reception of a preamble for random access in a general handover procedure.

The example of FIG. 3 illustrates an example in which the UE 330 transmits a preamble for random access to the target cell at one RO (e.g., RO #3) mapped to the preamble index and one designated SSB index (e.g., SSB #3) in the RACH configuration information to the target cell 320 in a handover process from the source cell 310 to the target cell 320.

Referring to FIG. 3, when determining to trigger handover based on the measurement information, the source cell 310 receiving the measurement information from the UE 330 transmits a handover request message to the target cell 310 in operation 301. When accepting the handover request in operation 302, the target cell 320 transmits a response message including cell configuration information about the target cell 320 to the source cell 310. In operation 303, the source cell 310 transmits an RRC message (i.e., an RRCReconfiguration message) including a handover command and the cell configuration information to the UE 330. The cell configuration information includes RACH configuration information, and the RACH configuration information includes one preamble index and one SSB index mapped to the RO for the UE to transmit a preamble in the random access procedure as in the example of Table 1 below. Table 1 below illustrates an example in which the SSB index is indicated as SSB #3 and the preamble index is indicated as “59”. In the example of FIG. 3, SSB #3 corresponds to the beam with the best received signal strength/quality based on the measurement information of the UE 330 among the candidate SSBs SSB #1, . . . SSB #8.

TABLE 1

```
Rach-ConfigDedicated
  CFRA
    resources
      ssb
        ssb-Resourcelist[0]
          ssb = 3
            ra_preambleIndex =59
```

In operation 304, the UE 330 performs a random access procedure for uplink synchronization with the target cell 320, and in the random access procedure, the UE 330 transmits a preamble for random access to the target cell at one RO RO #3 mapped to one SSB index SSB #3 and the preamble index based on the RACH configuration information.

However, in the operation of FIG. 3, an increase in waiting time (delay time) may occur during transmission/reception of a preamble for random access. Specifically, as illustrated at the lower end of FIG. 3, the UE 330 transmits a preamble for random access to the target cell 320 using one SSB index SSB #3 and preamble index mapped to the RO RO #3 of SFN #n (31), but the UE 330 may fail to receive a random access response (RAR) message from the target cell 320 according to the network circumstance (32). In this case, a waiting time 33 is required from the failure of the RAR reception at the RO RO #3 of SFN #n to the retransmission of the preamble at the next RO of SFN #n+1. The UE 330 may retransmit the preamble at RO #3 of SFN #n+1 after the waiting time 33 (34). Therefore, as the waiting time (T_{wait}) 33 increases, a handover interruption time (Tᵢₙₜₑᵣᵣᵤₚₜ) when user traffic is cut off may increase. The handover interruption time (Tᵢₙₜₑᵣᵣᵤₚₜ) may be represented as in the following Equation 1. TRACH is the time required in the random access procedure.

$${T}_{interrupt} ( interruption time ) = {T}_{wait} + {T}_{RACH} ( random access duration ) \qquad [ Equation 1 ]$$

Further, if the UE 330 fails to transmit a preamble at the RO due to network environment or UE capability issues, the UE 330 may transmit a preamble after waiting until the next RO comes. Further, when the UE fails to receive an RAR for the preamble transmitted at the position of the intended first RO due to, e.g., the speed of the UE 330, an abrupt change in RF environment such as fast fading or issues with UE processing during decoding of the MIB received from the target cell 320, it needs to wait for, at least, the RO of the next cycle, causing a significant increase in the logical preamble retransmission period. Due to this increase in waiting time 33, the UE 330 may be subjected to a traffic disconnected state and, when the number of beams for transferring SSBs increases in the communication environment such as massive MIMO in the 6G system as well as 5G systems, the influence of the waiting time 33 is expected to be significantly increased. Therefore, a measure is required to reduce the waiting time (delay time) generated when transmitting/receiving a preamble for random access in the handover procedure.

To that end, the disclosure proposes a method for reducing the waiting time (delay time) that occurs when a preamble is transmitted/received at a plurality of ROs mapped to a plurality of SSB indices of the target cell.

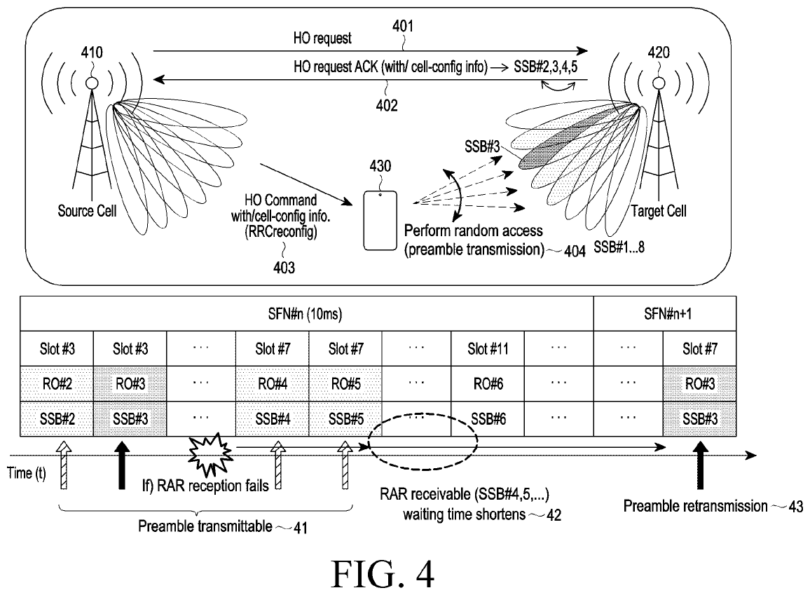

FIG. 4 is a view illustrating a method for transmitting/receiving a preamble for random access during handover in a wireless communication system according to an embodiment of the disclosure. In the disclosure, the source cell and the target cell may be understood as a source base station and a target base station, respectively, in a handover procedure.

The disclosure may be applied to a wireless communication system in which the target cell indicates, to the UE, the preamble index and SSB index (i.e., corresponding to the beam index of the target cell where the UE receives the corresponding SSB in the target cell) in the random access procedure during handover.

In the disclosure, RACH configuration information (included in the cell configuration information) including list information about the indices of a plurality of preambles that the target cell may receive in the random access procedure of the UE and SSB indices corresponding to the preamble indices may be configured in the target cell and be transferred to the source cell, and the source cell may transmit an RRC message (i.e., RRCReconfiguration message) including the handover command and the cell configuration information about the target cell to the UE. Then, the UE may perform the random access procedure by sequentially transmitting preambles from the preamble index corresponding to the closest RO based on the list information of the plurality of preamble indices and SSB indices mapped to the plurality of ROs in the RACH configuration information. The list information may be understood as SSB beam list information for preamble transmission in the random access procedure.

According to the disclosure, it is possible to significantly reduce the waiting time (delay time) that occurs when transmitting/receiving a preamble for random access in a handover procedure compared to the conventional method for transmitting a preamble for random access to the target cell at one RO mapped to one SSB index and preamble index.

Specifically, referring to FIG. 4, when determining to trigger handover based on the measurement information, the source cell 410 receiving the measurement information from the UE 430 transmits a handover request message to the target cell 420 in operation 401. When accepting the handover request in operation 402, the target cell 420 transmits a response message including cell configuration information about the target cell 420 to the source cell 410. In operation 403, the source cell 410 transmits an RRC message (i.e., an RRCReconfiguration message) including a handover command and the cell configuration information to the UE 430. The cell configuration information includes RACH configuration information proposed in the disclosure, and the RACH configuration information includes a plurality of preamble indices and a plurality of SSB indices mapped to a plurality of ROs for the UE to transmit a preamble in the random access procedure as in the example of Table 2 below.

TABLE 2

| CFRA ::= | SEQUENCE { |
|---|---|
| ..., | |
| resources | CHOICE { |
| ssb | SEQUENCE { |
| ssb-ResourceList | SEQUENCE |
| (SIZE(1..max-num-SSB)) OF CFRA-SSB-Resource, }, | |
| ..., | |
| } | |
| CFRA-SSB-Resource ::= | SEQUENCE { |
| ssb | SSB-Index, |
| ra-PreambleIndex | INTEGER (0..63), |
| ...,} | |
| CBRA ::= | SEQUENCE { |
| ..., | |
| resources | CHOICE { |
| ssb | SEQUENCE { |
| ssb-ResourceList | SEQUENCE |
| (SIZE(1.. max-num-SSB)) OF CBRA-SSB-Resource, }, | |
| ...,} | |
| CBRA-SSB-Resource ::= | SEQUENCE { |
| ssb | SSB-Index, |
| ra-PreambleIndex | INTEGER (0..63), |
| ...,} | |

In operation 404, the UE 330 starts a random access procedure for uplink synchronization with the target cell 320. In the random access procedure, the UE 430 may sequentially/selectively transmit a preamble using a plurality of SSB indices SSB #2, SSB #3, SSB #4, and SSB #5 and a plurality of preamble indices mapped to a plurality of ROs (e.g., RO #2, RO #3, RO #4, and RO #5) based on the RACH configuration information. According to the method of FIG. 4, a waiting time (delay time) during transmission/reception of a preamble for random access may be decreased. Specifically, as illustrated at the lower end of FIG. 4, the UE 430 transmits a preamble for random access to the target cell 320 using the SSB index SSB #3 and preamble index mapped to the RO RO #3 of SFN #n (41), but the UE 430 may fail to receive a random access response (RAR) message from the target cell 420 according to the network circumstance. In this case, in the above-described conventional method, a waiting time 33 is required to retransmit the preamble at the next RO of SFN #n+1 after failing in the RAR reception at the corresponding RO of SFN #n, but according to the method of FIG. 4, even when the RAR reception for the preamble transmitted from the RO #3 of SFN #n fails, the UE 430 may transmit the preamble for random access to the target cell 420 sequentially or selectively using the SSB indices SSB #4 and SSB #5 and the preamble indices mapped to RO #4 and RO #5, respectively, and receive the RAR from the target cell 420 (42). Accordingly, according to the disclosure, as illustrated in reference numeral 43 in FIG. 4, since the waiting time is not required until the next RO #3 of SFN #n+1 for retransmission of the preamble, the waiting time may be decreased, and the handover interruption time Tᵢₙₜₑᵣᵣᵤₚₜ when user traffic is cut off may be decreased.

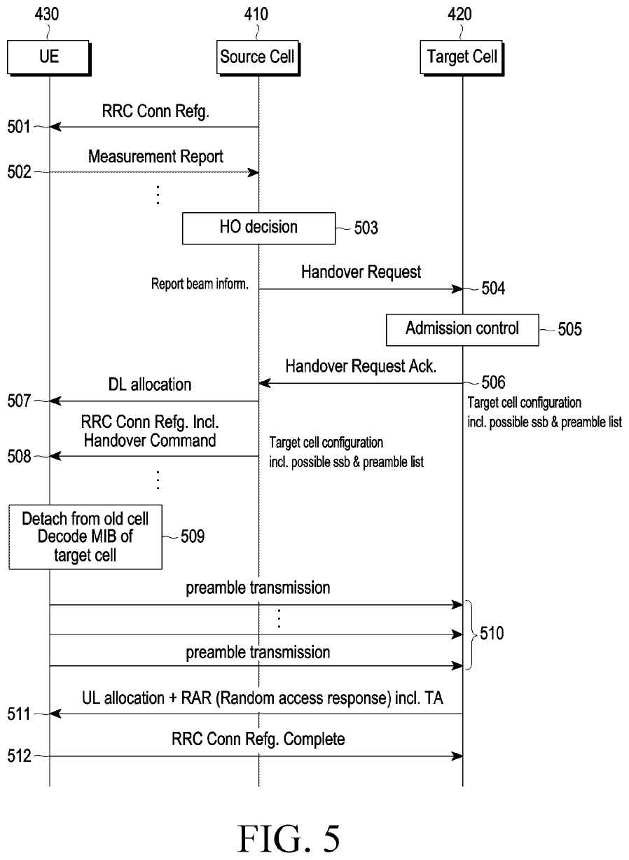

FIG. 5 is a flowchart illustrating a method for transmitting/receiving a preamble for random access during handover in a wireless communication system according to an embodiment of the disclosure.

Referring to FIG. 5, the source cell transmits the configuration information for channel state measurement of the UE to the UE in operation 501, and the UE measures the channel state (i.e., received signal strength/quality) based on the configuration information and reports it to the source cell in operation 502. In this case, the UE may measure the received signal strength/quality of the source cell and transmit the measurement information to the source cell periodically or when a set event occurs.

In operation 503, the source cell receiving the measurement information from the UE determines whether to trigger the handover based on the measurement information and, when it is determined to trigger the handover, in operation 504, the source cell transmits a handover request message for performing a handover procedure with one target cell with good received signal strength/quality among the neighbor cells. In operation 505, upon receiving the handover request message, the target cell performs acceptance control for the handover and, when accepting the handover, the target cell transmits a response message including cell configuration information for the handover procedure to the target cell to the source cell in operation 506. In the disclosure, the above-described RACH configuration information including a plurality of SSB indices and a plurality of preamble indices mapped to a plurality of ROs as list information for the UE to transmit a preamble in a random access procedure may be included in the cell configuration information. The response message may also include the identifier of the target cell, frequency information, identification information (C-RNTI) about the UE used in the target cell, or the like.

In the disclosure, the target cell may generate/configure the list information using the following 1-1) or 1-2) method. The list information may be referred to as beam list information.
1-1) A method where the UE includes information about a number of beams (i.e., beams corresponding to SSB indices) of the target cell reported through the measurement report in operation 501 in the list information
1-2) A method in which the target cell generates the list information according to the source cell or beam(s) of the UE (e.g., network sniffing, UE based automatic neighbor relation (ANR), etc.) The network sniffing is a method in which cells receive signals from neighbor cells for a predetermined period of time and share beam information between cells, and the UE-based ANR is a method in which when the UE performs an operation such as handover, the UE decodes the system information block (SIB) of neighbor cell(s) first and delivers it to the source cell, and the source cell uses the information to generate a neighbor list of neighbor cell(s).

Upon receiving the cell configuration information about the target cell including the RACH configuration information, the source cell may allocate a downlink resource to the UE in operation 507, and may transmit an RRC message (i.e., an RRCReconfiguration message) including a handover command and cell configuration information about the target cell to the UE in operation 508. In the disclosure, the list information included in the RACH configuration information may be selectively given a priority using the method of 2-1) or 2-2) below. The priority may be assigned from the target cell or the source cell.
2-1) List information having priority: A method in which the preamble index mapped to the SSB index corresponding to the best beam (i.e., the beam with the strongest received signal strength of SSB at the UE) of the target cell is designated as contention-free random access (CFRA) (1st priority), and the preamble index(es) mapped to the SSB indices for the remaining beam(s) where the target cell transmits the SSB(s) are designated as contention-based random access (CBRA) (2nd priority) to generate list information about the preamble indices mapped to the SSB indices.
2-2) List information with no priority: A method in which the preamble indices for all the beams where the target cell transmits SSBs are designated as CFRA regardless of the best beam of the target cell. This method may be used when the target cell knows all of the load information about the neighbor cell(s).

In operation 509, the UE receiving the cell configuration information including the RACH configuration information about the target cell through the handover command from the source cell (i.e., old cell) switches the RF to perform the handover procedure to the target cell, decodes the MIB of the target cell, and obtains the SFN of the target cell (i.e., obtains downlink (DL) synchronization). Thereafter, the UE starts a random access procedure to obtain uplink synchronization.

In operation 510, the UE that started the random access procedure may sequentially or selectively transmit the preamble using the plurality of SSB indices and the plurality of preamble indices mapped to the plurality of ROs based on RACH configuration information including the list information.

In the disclosure, the UE may sequentially or selectively transmit the preamble using one of the following 3-1) to 3-3) methods.
3-1) The UE may transmit preambles sequentially from the SSB index mapped to the RO that may be tried first for all of the ROs in the list information. In this case, the UE may sequentially transmit the preamble from the RO that has reached the transmittable time of the preamble, regardless of whether the RAR is received for the previously transmitted preamble.
3-2) When the RAR window when the UE may receive the RAR for the previously transmitted preamble has not expired (i.e., when it cannot determine whether the previous preamble transmission succeeds/fails), the preamble at the corresponding time may not be transmitted.
3-3) The UE may perform one RA procedure at a time. In other words, when the RAR window expires for one preamble transmission, the UE may perform the RA procedure sequentially for the plurality of SSB indices in the way of power ramping and waiting->performing next RA procedure.

In operation 511, the UE may receive an RAR message including an uplink allocation (UL grant) from the target cell that has received the preamble. In operation 512, the UE receiving the RAR message transmits an RRC message msg3 including the C-RNTI of the UE through the PUSCH. The RRC message msg3 may use an RRC reconfiguration complete message (RRCReconfigurationComplete) in the case of a 5G system.

In operations 511 and 512, in this case, when there is one RAR message transmitted from the target cell, the UE may transmit the RRC message msg3 on the corresponding UL grant. In an optional embodiment, when the target cell receives a second preamble from the UE before transmitting the RAR message for the first preamble received from the UE, the target cell may transmit the RAR messages for both of the preambles to the UE. In this case, since the target cell receives two different preambles in the same C-RNTI and allocates different UL grants, the UL resource to receive, of the RRC message msg3, may be identified, and the UE may transmit one RRC message msg3 for the reception of the two RAR messages. Meanwhile, if the target cell receives another preamble having the same C-RNTI after receiving the RRC message msg3 from the UE, the reception of the preamble may be ignored. Further, in the disclosure, the target cell may transmit RAR messages (which may include different TC-RNTIs) for all of the of the preambles received from the UE, and may allocate UL grant to the UE in each RAR message. Further, the UE may transmit the RRC message msg3 for the first RAR message received from the target cell. In operation 512, the UE transmits a ReconfigurationComplete message for the first received RAR message, and terminates the random access procedure using the remaining preamble index(s).

In the disclosure, the base stations of the source cell and/or target cell may support radio resource control (RRC) layer, lower layer receiving measurement information from the UE, and the above-described network sniffing determining the surrounding circumstance, and ANR to generate the above-described measurement information and list information. Further, the base stations of the disclosure may include a data unit (DU) and/or central unit (CU) as a functional block including an interface including the function of transferring the list information to the source base station or transferring measurement information about the plurality of beams reported by the UE to the handover target base station using, e.g., stream control transmission protocol (SCTP) (e.g., handover request).

Further, when generating/configuring the above-described list information, the base station of the target cell in the disclosure may differently configure the list information depending on whether there is surrounding base station information and generate the list information using the reported beam information in the handover request received from the base station of the source cell. Further, the base station of the target cell knows all of the information about the surrounding base stations and, when determining that mobility information may be inferred for several seconds in the future through artificial intelligence (AI) learning or load information about the surrounding base stations, generate/configure the list information based only on the information possessed by the base station of the target cell. Further, the base station of the target cell may set the priority to the list information as described above according to the presence of surrounding base stations or the internal operation of the base station.

Further, in the disclosure, the UE may include at least one MAC entity (medium access control) (or at least one random access controller) supporting the monitoring of transmission of a preamble and reception of an RAR message according to the operation of the disclosure, an RRC layer capable of receiving and decoding an RRC message (i.e., RRCReconfiguration message) including cell configuration information including the RACH configuration information about the target cell and the measurement report, and at least one lower layer (PHY layer) that receives and decodes the MIB of the target cell to obtain the SEN and supports the reception monitoring. The base stations of the source cell and/or target cell and the UE may be implemented to include a transceiver for transmitting/receiving signals through a wireless network and at least one processor (or controller), and the at least one processor (or controller) and/or transceiver may be understood as a combined component of software and/or hardware corresponding to functional blocks such as MAC entity, lower layer, and RRC layer that control operations according to embodiments of the disclosure.

Further, the UE may receive the list information from the target cell via the source cell in the handover procedure and determine the transmission method of the preamble based on the list information according to the number of MAC entity(ies) and/or RAC(s) in the UE. Even when the UE uses one MAC entity and one RAC like the conventional UE, the preamble may be transmitted according to an embodiment of the disclosure in a manner of performing one RA procedure at a time.

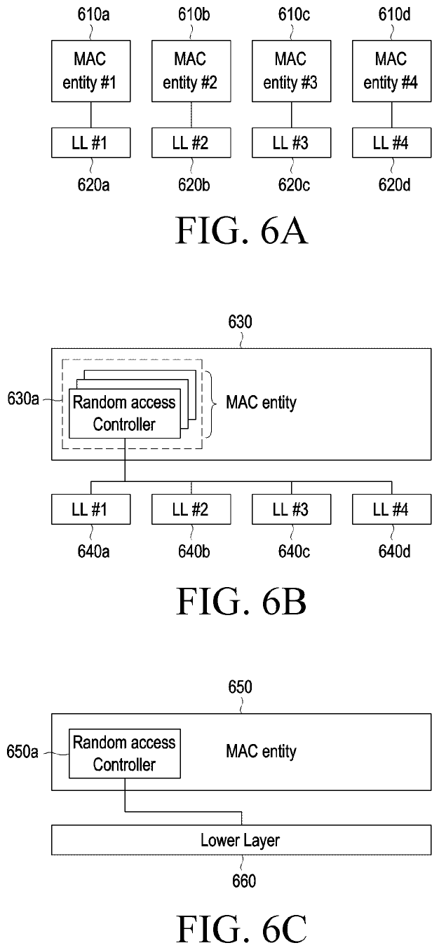

FIGS. 6A, 6B, and 6C are views illustrating various configuration examples of a UE performing a random access procedure during handover in a wireless communication system according to an embodiment of the disclosure.

FIG. 6A illustrates an example in which a UE uses a plurality of MAC entities. In this case, the UE has a plurality of MAC entities 610a, . . . , 610d and lower layers 620a, . . . , 620d connected to the plurality of MAC entities 610d, . . . , 610d. The UE having the configuration of FIG. 6A may sequentially/selectively transmit preambles at a plurality of ROs under the control of MAC entities 610a, . . . , 610d, and may transmit a preamble when reaching an RO of the transmittable time regardless of whether an RAR for the previously transmitted preamble is received. For example, an RA procedure may be performed for each RO by the number of LLs/MAC entities sequentially in a manner like LL #1 (620a)->RO #3, LL #2 (620b)->RO #4, LL #3 (620c)->RO #5, . . . . The numbers of MAC entities and lower layers are an example, and at least two or more MAC entities and lower layers may be included in the UE.

FIG. 6B illustrates an example in which a UE uses a plurality of random access controllers (RACs) included in one MAC entity. In this case, the UE has one MAC entity 630 and lower layers 640a, . . . , 640d connected to the MAC entity 630. The UE having the configuration of FIG. 6B may sequentially/selectively transmit preambles at a plurality of ROs under the control of the plurality of RACs 630a in the MAC entity 630, and may transmit a preamble when reaching an RO of the transmittable time regardless of whether an RAR for the previously transmitted preamble is received. For example, an RA procedure may be performed for each RO by the number of RACs in the LL/MAC entity sequentially in a manner like LL #1 (640a)->RO #3, LL #2 (640b)->RO #4, LL #3 (640c)->RO #5, . . . .

FIG. 6C illustrates an example in which a UE uses one RAC included in one MAC entity. In this case, the UE has one MAC entity 650 and one lower layer 660 connected to the MAC entity 650. Since there is one RAC, the UE having the configuration of FIG. 6C may perform one RA procedure at a time. When the RAR window expires for one preamble transmission, the UE may perform the RA procedure for each RO in a manner of performing power ramping and then waiting->performing the RA procedure for the next RO.

To support the operation of the UE having the configuration of FIGS. 6A, 6B and 6C, information (support_multiple_mac_entity, maximum_number_of_mac_entity) indicating the number of MAC entities/RACs that the UE may support and/or the maximum number of MAC entities/RACs may be included in the UE capability information transmitted by the UE to the base station.

For example, information indicating whether the UE supports a plurality of MAC entities, a plurality of RACs, or one MAC entity/RAC, such as support_multiple_mac_entity=choice {MAC, RAC, NONE}, may be included in the UE capability information. Further, information capable of indicating the maximum number of the plurality of MAC entities or the plurality of RACs in the UE, such as maximum_number_of_mac_entity=choice {1 . . . }, may be included in the UE capability information.

Further, the UE capability information in the disclosure may include information indicating whether the UE supports a preamble transmission function using a plurality of SSB indices and a plurality of preamble indices mapped to a plurality of ROs according to embodiments of the disclosure, such as support_multiple_preamble=choice {boolen}.

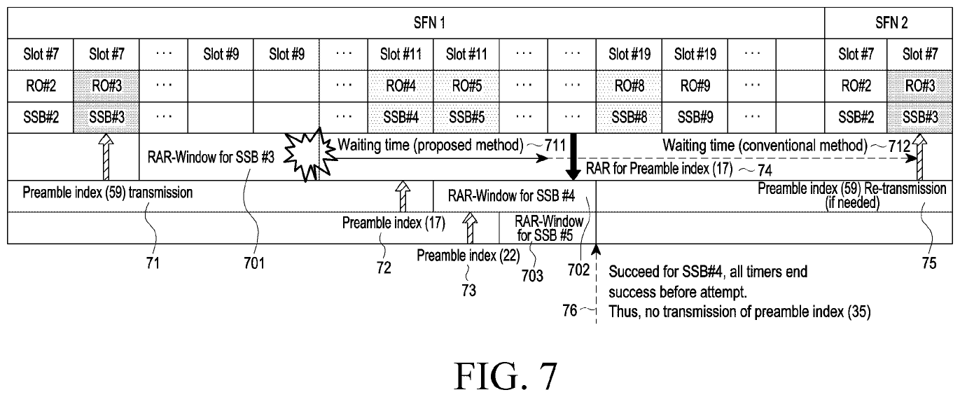

FIG. 7 is a view illustrating an example of an operation of transmitting/receiving a preamble for random access during handover according to an embodiment of the disclosure.

The operation example of FIG. 7 assumes that list information, such as those shown in tables 3 and 4 below, is provided to the UE from the target cell through the source cell.

TABLE 3

| RO list of target | CB preamble | CF preamble |
|---|---|---|
| base station | Index | Index |
| . . . | . . . | . . . |
| SSB#3 (RO#3) | 12, 13, 14, 15 | 59 |
| SSB#4 (RO#4) | 16, 17, 18, 19 | 60 |
| SSB#5 (RO#5) | 20, 21, 22, 23 | 61 |
| . . . | . . . | . . . |
| SSB#8 (RO#8) | 32, 33, 34, 35 | — |
| . . . | . . . | . . . |

TABLE 4

```
CFRA
  resources
  ssb
    ssb-ResourceList[0]
      ssb = 3
      ra_PreambleIndex = 59
CBRA
  resources
  ssb
    ssb-ResourceList[0]
      ssb = 4
      ra-PreambleIndex = 17
    ssb-ResourceList[1]
      ssb = 5
      ra-PreambleIndex = 22
    ssb-ResourceList[2]
      ssb = 8
      ra-PreambleIndex = 35
```

Referring to FIG. 7, the UE transmits a preamble for random access to the target cell using the SSB index SSB #3 and the preamble index 59 mapped to the RO #3 of SFN1 (71), but according to the network circumstance, the UE may fail to receive a random access response (RAR) message in the RAR window 701 for the SSB index SSB #3 from the target cell. In this case, even when the RAR reception for the preamble transmitted from RO #3 of SFN1 fails, the UE may sequentially transmit the preamble for random access to the target cell using the SSB indices SSB #4 and SSB #5 and preamble indices 17 and 22, respectively, mapped to RO #4 and RO #5 (72 and 73), and receive the RAR from the target cell (74). The example of FIG. 7 illustrates a case where the RAR is successfully received in the RAR window 702 for the SSB index SSB #4 out of the RAR windows 702 and 703 for the SSB indices SSB #4 and SSB #5 mapped to the preamble indices 17 and 22. When the RAR is successfully received, the UE terminates all of the related timers and does not perform preamble transmission of the preamble index 35 in SFN1 (76), and does not perform preamble retransmission of the preamble index 59 in SFN2 (75). While the conventional method requires a waiting time 712 of T_{wait} 10 ms or more when failing to receive the RAR for the first SSB #3, the operation of the disclosure as in the example of FIG. 7 may significantly reduce the waiting time 711, e.g., to T_{wait} 1 to 4 ms, although failing to receive the RAR for the first SSB #3. Accordingly, according to the disclosure, it is possible to significantly reduce the handover interruption time (Tᵢₙₜₑᵣᵣᵤₚₜ) when user traffic is cut off.

Meanwhile, as an optional embodiment, in the example of FIG. 7, when determining that preamble transmission attempted at slot #7 for SSB #3 fails, the UE may terminate the random access procedure for SSB #3 when slot #11 for SSB #4 when another preamble is newly transmittable is reached, and perform the operation of increasing the counter by “1” for SSB #3 transmission inside the UE. The UE may start a random access procedure for SSB #4 newly at slot #11 and, although the transmittable next slot timing comes when success/failure is not yet determined for SSB #4, may refrain from transmitting a preamble. Further, when all intermediate preamble transmissions fail, and slot #7 of the next SFN2 arrives, the UE sets the retransmission counter inside the UE according to the counter for SSB #3 inside the UE and raises the preamble ramping step (i.e., increasing transmission power) and retransmit the preamble.

Further, as an optional embodiment, the UE using a plurality of MAC entities or a plurality of RACs may map the UE ID, such as TC-RNTI, for the first received RAR among the plurality of preambles transmitted by the UE to its own UE ID, such as C-RNTI, to find an uplink resource where msg3 transmission is possible. Further, when an RAR other than the first received RAR is received, the UE may disregard the other RAR and, when receiving an RAR, terminate all other random access procedures than the corresponding random access procedure.

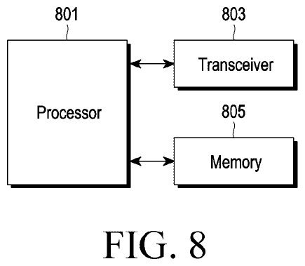

FIG. 8 is a view illustrating a configuration of a network entity in a wireless communication system supporting an RIS according to an embodiment of the disclosure. The configuration of FIG. 8 may correspond to one of the base station, the UE, and the RIS device described in the embodiments of FIGS. 4 to 8.

The network entity of FIG. 8 may include a processor 801, a transceiver 803, and memory 805. The processor 801, transceiver 803, and memory 805 of the network entity may be operated according to the communication methods of the network entity described above in connection with the embodiments of FIGS. 1 to 13. However, the components of the network entity are not limited thereto. For example, the network entity may include more or fewer components than the above-described components. The processor 801, the transceiver 803, and the memory 805 may be implemented in the form of a single chip. The transceiver 803 collectively refers to the receiver of the network entity and the transmitter of the network entity and may transmit and receive signals to/from a UE or another network entity. The transmitted/received signals may include at least one of control information and data. To that end, the transceiver 803 may include a wired/wireless transceiver and may include various components for transmitting/receiving signals. The transceiver 803 may receive signals, output the signals to the processor 801, and transmit the signals output from the processor 801. Further, the transceiver 803 may receive the communication signal and output it to the processor 801 and transmit the signal output from the processor 801 to another network entity through the network. The memory 805 may store programs and data necessary for the operation of the network entity according to at least one of the embodiments of FIGS. 4 to 8. Further, the memory 805 may store control information or data that is included in the signal obtained by the network entity. The memory 805 may include a storage medium, such as ROM, RAM, hard disk, CD-ROM, and DVD, or a combination of storage media. Further, the processor 801 may control a series of processes so that the network entity may operate according to at least one of the embodiments of FIGS. 1 to 8. For example, the processor 801 may include at least one processor.

The methods according to the embodiments descried in the specification or claims of the disclosure may be implemented in hardware, software, or a combination of hardware and software.

When implemented in software, there may be provided a computer readable storage medium storing one or more programs (software modules). One or more programs stored in the computer readable storage medium are configured to be executed by one or more processors in an electronic device. One or more programs include instructions that enable the electronic device to execute methods according to the embodiments described in the specification or claims of the disclosure.

The programs (software modules or software) may be stored in random access memories, non-volatile memories including flash memories, read-only memories (ROMs), electrically erasable programmable read-only memories (EEPROMs), magnetic disc storage devices, compact-disc ROMs, digital versatile discs (DVDs), or other types of optical storage devices, or magnetic cassettes. Or, the programs may be stored in memory constituted of a combination of all or some thereof. As each constituting memory, multiple ones may be included.

The programs may be stored in attachable storage devices that may be accessed via a communication network, such as the Internet, Intranet, local area network (LAN), wide area network (WLAN), or storage area network (SAN) or a communication network configured of a combination thereof. The storage device may connect to the device that performs embodiments of the disclosure via an external port. A separate storage device over the communication network may be connected to the device that performs embodiments of the disclosure.

In the above-described specific embodiments, the components included in the disclosure are represented in singular or plural forms depending on specific embodiments proposed. However, the singular or plural forms are selected to be adequate for contexts suggested for ease of description, and the disclosure is not limited to singular or plural components. As used herein, the singular forms “a,” “an,” and “the” are intended to include the plural forms as well, unless the context clearly indicates otherwise.

Although specific embodiments of the present invention have been described above, various changes may be made thereto without departing from the scope of the present invention. Thus, the scope of the disclosure should not be limited to the above-described embodiments, and should rather be defined by the following claims and equivalents thereof.

1. A method of a user equipment (UE) for random access during handover from a source cell to a target cell in a wireless communication system, the method comprising:
transmitting measurement information about the source cell and the target cell to a first base station of the source cell;
receiving a radio resource control (RRC) message including random access channel (RACH) configuration information about the target cell from the first base station; and
sequentially transmitting at least one preamble for the random access to a second base station of the target cell based on the RACH configuration information,
wherein the RACH configuration information includes a plurality of synchronization signal block (SSB) indices and a plurality of preamble indices mapped to a plurality of RACH occasions (ROs) for the UE to transmit the at least one preamble in a random access procedure as list information.

2. The method of claim 1, wherein the at least one preamble is transmitted sequentially from an SSB index mapped to an RO that is capable of first being attempted on the ROs in the list information,
wherein the method comprises, in response to the transmission of the preamble, receiving a random access response (RAR) message from the second base station, and
wherein the transmitting further includes transmitting the preamble sequentially from an RO reaching a time when the preamble is transmittable, regardless of whether the RAR message is received for a previously transmitted preamble.

3. The method of claim 1, wherein in the list information, a preamble index mapped to a first SSB index corresponding to an SSB beam with a strongest reception signal strength among the plurality of SSB indices is designated as content-free random access (CFRA), and preamble indices mapped to SSB indices corresponding to remaining SSB beams transmitting SSBs in the target cell are designated as content-based random access (CBRA), and
wherein the preamble indices mapped to the plurality of SSB indices in the list information are designated as the CFRA.

4. The method of claim 1, wherein the UE sequentially transmits the at least one preamble in the same system frame number (SFN) using at least one medium access control (MAC) entity or at least one random access controller (RAC).

5. The method of claim 1, wherein when the UE transmits the at least one preamble using one MAC entity or one RAC, sequentially transmitting a next preamble in a next random access procedure after performing power ramping after an RAR window expires for transmission of one preamble.

6. A UE performing random access during handover from a source cell to a target cell in a wireless communication system, comprising:
a transceiver; and
at least one processor configured to transmit, through the transceiver, measurement information about the source cell and the target cell to a first base station of the source cell;
receive, through the transceiver, a radio resource control (RRC) message including random access channel (RACH) configuration information about the target cell from the first base station; and
sequentially transmit, through the transceiver, at least one preamble for the random access to a second base station of the target cell based on the RACH configuration information,
wherein the RACH configuration information includes a plurality of synchronization signal block (SSB) indices and a plurality of preamble indices mapped to a plurality of RACH occasions (ROs) for the UE to transmit the at least one preamble in a random access procedure as list information.

7. The UE of claim 6, wherein the at least one preamble is transmitted sequentially from an SSB index mapped to an RO that is capable of first being attempted on the ROs in the list information, and
wherein the at least one processor is further configured to receive, through the transceiver, a random access response (RAR) message from the second base station in response to the transmission of the preamble and sequentially transmit the preamble from an RO reaching a time when the preamble is transmittable, regardless of whether the RAR message is received for a previously transmitted preamble.

8. The UE of claim 6, wherein in the list information, a preamble index mapped to a first SSB index corresponding to an SSB beam with a strongest reception signal strength among the plurality of SSB indices is designated as content-free random access (CFRA), and preamble indices mapped to SSB indices corresponding to remaining SSB beams transmitting SSBs in the target cell are designated as content-based random access (CBRA), and
wherein the preamble indices mapped to the plurality of SSB indices in the list information are designated as the CFRA.

9. The UE of claim 6, wherein the at least one processor is configured to sequentially transmits the at least one preamble in the same system frame number (SFN) using at least one medium access control (MAC) entity or at least one random access controller (RAC).

10. The UE of claim 6, wherein when the UE transmits the at least one preamble using one MAC entity or one RAC, the at least one processor is configured to sequentially transmit, through the transceiver, a next preamble in a next random access procedure after performing power ramping after an RAR window expires for transmission of one preamble.

11. A method performed by a base station of a target cell for random access during handover from a source cell to the target cell in a wireless communication system, the method comprising:
transmitting a radio resource control (RRC) message including random access channel (RACH) configuration information about the target cell to a first base station of the source cell; and
sequentially receiving at least one preamble for the random access from a UE based on the RACH configuration information,
wherein the RACH configuration information includes a plurality of synchronization signal block (SSB) indices and a plurality of preamble indices mapped to a plurality of RACH occasions (ROs) for the UE to transmit the at least one preamble in a random access procedure as list information.

12. The method of claim 11, wherein in the list information, a preamble index mapped to a first SSB index corresponding to an SSB beam with a strongest reception signal strength among the plurality of SSB indices is designated as content-free random access (CFRA), and preamble indices mapped to SSB indices corresponding to remaining SSB beams transmitting SSBs in the target cell are designated as content-based random access (CBRA), and
wherein the preamble indices mapped to the plurality of SSB indices in the list information are designated as the CFRA.

13. A base station of a target cell supporting random access during handover from a source cell to the target cell in a wireless communication system, comprising:
a transceiver; and
at least one processor configured to transmit, through the transceiver, a radio resource control (RRC) message including random access channel (RACH) configuration information about the target cell to a first base station of the source cell; and
sequentially receive, through the transceiver, at least one preamble for the random access from a UE based on the RACH configuration information,
wherein the RACH configuration information includes a plurality of synchronization signal block (SSB) indices and a plurality of preamble indices mapped to a plurality of RACH occasions (ROs) for the UE to transmit the at least one preamble in a random access procedure as list information.

14. The base station of claim 13, wherein in the list information, a preamble index mapped to a first SSB index corresponding to an SSB beam with a strongest reception signal strength among the plurality of SSB indices is designated as content-free random access (CFRA), and preamble indices mapped to SSB indices corresponding to remaining SSB beams transmitting SSBs in the target cell are designated as content-based random access (CBRA), and wherein

15. The base station of claim 13, wherein the preamble indices mapped to the plurality of SSB indices in the list information are designated as the CFRA.
